(19) United States
(12) Patent Application Publication
(10) Pub. No.: US 2024/0037650 A1
(43) Pub. Date: Feb. 1, 2024

(54) CRYPTOGRAPHIC LENDING INSTRUMENTS AND TRANSACTION SYSTEM AND METHOD THEREOF

(71) Applicant: Celligence International LLC, Guaynabo, PR (US)

(72) Inventors: Pavan AGARWAL, Dorado, PR (US); Gabriel Albors SANCHEZ, San Juan, PR (US); Jonathan Ortiz RIVERA, San Juan, PR (US); Thomas SMITH, Guaynabo, PR (US)

(73) Assignee: Celligence International LLC, Guaynabo, PR (US)

(21) Appl. No.: 18/226,741

(22) Filed: Jul. 26, 2023

Related U.S. Application Data
(60) Provisional application No. 63/392,756, filed on Jul. 27, 2022.

(51) Int. Cl. G06Q 40/03; H04L 9/00; G06Q 50/16; H04L 9/40; H04L 51/04

(52) U.S. Cl. CPC G06Q 40/03; H04L 9/50; G06Q 50/16; H04L 63/083; H04L 51/04; G06Q 2220/00

(57) ABSTRACT

Methods and processes can include disbursement and/or management and issuance of guaranteed preapprovals in real-estate transactions reordered as offers to purchase real estate property sold by sellers smart in a distributed digital ledger system. In some embodiments, holders of guaranteed preapproval NFTs may be linked to offers to purchase real also recorded as NFTs. Holders of guaranteed preapproval NFTs may make a plurality of offers to purchase a plurality of real estate properties using natural language commands within a conversation or chat interface associated with a real-estate transaction application.

### RELATED APPLICATIONS

This application claims the benefit of U.S. Provisional Application No. 63/392,756 filed on Jul. 27, 2022, the contents of which are incorporated herein by reference in its entirety.

### TECHNICAL FIELD

The present disclosure generally relates to distributed ledger computer systems. More particularly, the present disclosure relates to computer systems and processes for providing, administering, and/or managing agreements backed by guaranteed preapprovals using blockchain technology.

### SUMMARY

In accordance with one or more embodiments, various features and functionality can be provided to enable or otherwise facilitate transactions related to making real-estate purchases via an exchange of natural language commands in a conversation interface of a real-estate transaction application.

In some embodiments, the system for transferring digital assets via an exchange of natural language commands in a conversation interface of a real-estate transaction application may include establishing, by a processor, a first real-estate transaction application in a data store connected to the processor. Next, the system may include storing login information for the first real-estate transaction application.

In some embodiments, login credentials for the first real-estate transaction application from a first buyer device may be received. Next, whether the login credentials match the login information for the first real-estate transaction application may be verified.

Upon verifying the login credentials, the first buyer device may be logged into the first real-estate transaction application. Once logged in, a first buyer input may be obtained. The first input may comprise a command to make a first offer to purchase a real estate property sold by a seller using an issued guaranteed mortgage preapproval command displayed within a conversation interface of the first real-estate transaction application. The conversation interface may be configured to receive user input and display assistant user input (e.g., comprising one or more responses generated by an assistant user based on the user input).

The system may identify the issued guaranteed mortgage preapproval obtained by the first buyer from a lender by using the command of the first buyer. The guaranteed mortgage preapproval may be represented by a cryptographic digital asset governed by a smart contract on a blockchain. The cryptographic digital asset may comprise a non-fungible token (NFT) and may store the first buyer information, property information, and seller information.

In some embodiments, a first offer record for storing contract data regarding terms of the first offer in a blockchain or a database may be prepared. The first offer may be a smart contract that includes computer-readable instructions for verifying, authenticating and approving a property transfer-related event according to the terms and conditions of the first offer. The first offer may not have been accepted by the seller of the real estate property.

In some embodiments, the guaranteed mortgage preapproval NFT may be linked with the first offer record for recordation in a new block in the blockchain distributed ledger. Additionally, the first offer record linked to the guaranteed mortgage preapproval NFT obtained by the first buyer may be linked with a record for the real estate property sold by the seller in the blockchain distributed ledger.

In some embodiments, the system may identify the issued guaranteed mortgage preapproval obtained by the second buyer in response to obtaining a command of the second buyer. The input of the second buyer may comprise a command to make a second offer to purchase the real estate property sold by the seller using the issued guaranteed mortgage preapproval obtained by the second buyer. Upon identifying the issued guaranteed mortgage preapproval obtained by the second buyer, a second offer record for storing contract data regarding terms of the second offer in the blockchain or the database may be prepared.

In some embodiments, the second buyer's guaranteed mortgage preapproval NFT may be linked with the second offer record in the blockchain distributed ledger. Additionally, the second offer record linked to the guaranteed mortgage preapproval NFT obtained by the second buyer may be linked with the record for the real estate property sold by the seller in the blockchain distributed ledger.

In some embodiments, a first input from the seller comprising a command to accept the first offer to purchase the real estate property made by the first buyer may be obtained. Then, a first acceptance record for storing contract data regarding terms of the acceptance of the first offer in the blockchain or the database may be prepared. Finally, the first offer record may be linked with the first acceptance in the blockchain distributed ledger. By contrast, a first rejection record for storing contract data regarding rejection of the second offer in the blockchain or the database may be prepared, and the second offer record may be linked with the first rejection record in the blockchain distributed ledger.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 illustrates an example system for generating and transferring cryptographic digital lending assets, according to an implementation of the disclosure.

FIG. 2A illustrates a digital copy of a guaranteed preapproval issued to a buyer, according to an implementation of the disclosure.

FIG. 2B illustrates a block diagram that illustrates an example cryptographic guaranteed preapproval token, according to an implementation of the disclosure.

FIG. 2C illustrates a block diagram that illustrates an example cryptographic real-estate agreement token, according to an implementation of the disclosure.

FIG. 2D illustrates a block diagram that illustrates a TRUApproval bundle, according to an implementation of the disclosure.

FIGS. 3A-3B illustrate example processes for swapping the cryptographic digital lending assets, according to an implementation of the disclosure.

FIGS. 4A-4B illustrate example processes for using a plurality of cryptographic digital lending assets, according to an implementation of the disclosure.

FIG. 4C illustrates an example system using a conversation interface assisted by an automated software assistant to effectuate transactions for cryptographic digital lending assets, according to an implementation of the disclosure.

FIGS. 4D-4E illustrate example conversation interfaces using the conversation interface assisted by the automated software assistant illustrated in FIG. 4C to make transactions using cryptographic digital lending assets, according to an implementation of the disclosure.

FIG. 5 illustrates a method for swapping cryptographic digital lending assets, according to an implementation of the disclosure.

FIG. 6 illustrates an example computing system that may be used in implementing various features of embodiments of the disclosed technology.

Described herein are systems and methods for generating and swapping cryptographic digital lending assets. The details of some example embodiments of the systems and methods of the present disclosure are set forth in the description below. Other features, objects, and advantages of the disclosure will be apparent to one of skill in the art upon examination of the following description, drawings, examples and claims. It is intended that all such additional systems, methods, features, and advantages be included within this description, be within the scope of the present disclosure, and be protected by the accompanying claims.

### DETAILED DESCRIPTION

In a current seller's market, the demand for housing exceeds supply. With fewer homes available, bidding wars have become more common, and buyers are often forced to make sacrifices. In an effort to ensure that nothing gets in the way of their purchase, buyers try to make their offers as enticing as possible. For example, making an “all-cash offer,” may be one way to secure the buy. However, not all buyers have the necessary cash. Moreover, “cash buyers” (i.e., buyers making “all-cash” offers) can sometimes be overly difficult and, therefore, less attractive to sellers. Accordingly, some buyers that need to finance their purchase, will go the route of a “no financing (or mortgage) contingency” route, which effectively equates their mortgage offer to an “all-cash” offer. A “no financing contingency” offer waives financing contingencies (i.e., difficulties that buyer may experience in actually being able to obtain the mortgage loan from the lender) and indicates that a buyer is serious and determined to close. Most buyers that issue a no financing contingency offer do so on the basis of having a preapproval from the lender

However, being preapproved for a mortgage may not guarantee that buyers will actually be able to obtain the funds they need to purchase the property. Thus, waiving a financing (or mortgage) contingency can be risky, as it prevents buyers from being able to back out of an agreement to buy in the event their financing falls through. In other words, without this contingency, buyers are still obligated to surrender their earnest money or pay the full purchase price of the home regardless of whether they have the funds.

By issuing a “guaranteed” preapproval, a lender not only provides the preapproval but essentially backs the mortgage as if the transaction went through. This type of preapproval removes some of the buyer's risks, e.g., not qualifying for the loan despite being preapproved, as discussed above, because it guarantees that the loan will be issued. For example, a guaranteed preapproval issued by a Sun West Mortgage Company, Inc. (“Sun West”) is known as a “TRUApproval”. Thus, a guaranteed preapproval not only lowers a buyer's risk it also increases a seller's confidence that the transaction will go through by effectively removing any likelihood that a buyer will be unable to pay the purchase price as agreed. This is not possible with a standard, non-guaranteed preapproval, as buyers often encounter hurdles in getting the lender to fund the loan, despite being initially preapproved. Accordingly, a seller is more willing to accept an offer from a buyer that has both waived a financing contingency and secured a guaranteed preapproval from a lender (e.g., a TRUAppoval), than any other offer, including an “all cash” one.

After the offer backed by a guaranteed preapproval (known as a “guaranteed preapproval offer”) has been accepted by the seller, the closing often takes place within sixty or so days. In the current volatile real-estate market, the market conditions change rapidly, it may be beneficial for the buyer to exploit the changing market during the pre-closing period (i.e., the period commencing as of the date of the buy-sell agreement and ending on the closing date).

One way to exploit the market is to allow the buyer to “trade” the guaranteed preapproval offer with another buyer who has also received a guaranteed preapproval. For example, a buyer may “sell” their offer to buy a house for $100,000 for $150,000 to another buyer. During the closing, the second buyer will close on the $100,000 property and the original buyer will receive $50,000 in profit.

Traditionally, these types of transactions are not possible as offers to buy are non-transferrable from buyer to buyer. However, by converting the guaranteed preapproval offer to a cryptographic digital asset, results in the buyer using the cryptographic asset for transacting on a secure decentralized ledger that is distributed throughout its open network. For example, this decentralized ledger, known as the blockchain, allows participants in the network to transact without the need for a trusted third party, such as a bank. This electronic ledger resides on the blockchain and, as such, may be immutable and accessible at any node on the blockchain network.

The blockchain is generated and distributed by any distributed computing platform and operating system. One such example is the Ethereum platform, one of several cryptocurrency platforms that provide for the formation and execution of smart contracts and for running blockchain applications.

In accordance with various embodiments, a system for enabling real-estate agreements that are transacted via a distributed ledger network is disclosed. On the distributed ledger system, smart contracts can be created and recorded to memorialize these real-estate agreements, record seller information, record owner information, record contingency information (e.g., financing contingency), record property information including purchase price, lender and the type of preapproval (e.g., guaranteed preapproval), and/or record closing or satisfaction of the agreement.

As described earlier, prior to entering into a real-estate agreement, a buyer must secure a guaranteed preapproval from a lender. In one embodiment, a lending entity may approve prospective borrowers based on creditworthiness or other factors as may be desirable. In other embodiments, borrowers are selected according to specified criteria. For example, the lending entity may use criteria for selecting borrowers similar to the criteria currently in use for traditional financing operations. Similarly, the lending entity may consider loan-to-value ratio, debt-to-income ratio, credit score, or other factors relevant to the loan risk. In other words, potential loans may be analyzed and considered in a manner similar to that of a conventional lending operation. Once the lender approves the borrower's request, the lender issues the guaranteed approval as a cryptographic token. Within the context of blockchain technology, a cryptographic token (a crypto token or token) generally refers to a unit of value for a programmable asset that is managed by a smart contract and an underlying distributed ledger. Tokens are the primary means of transferring and storing value on a blockchain network—most often Ethereum. Tokens can also be designed to either be fungible or non-fungible (non-fungible tokens are known as “NFTs”), depending on a network's specific needs.

The guaranteed preapproval issued by the lender as an NFT will be linked to the borrower. Furthermore, the smart contract (or a smart subcontract, and or any combination of these components) used to manage the guaranteed preapproval token may be initialized to memorialize the details, rules, conditions, and other such information associated with the issuance of the guaranteed preapproval. For example, the conditions under which the lender has the ability to revoke the guaranteed preapproval may be embedded into the smart contract. In various embodiments, the guaranteed preapproval can be tracked by a digital wallet. Additionally, all guaranteed preapprovals issued by a particular lender will have the same conditions. Thus, by virtue of all guaranteed preapprovals having the same conditions allows for them to be exchangeable, as will be described in detail herein.

Next, the buyer may use the guaranteed preapproval token to make offers to purchase real-estate from sellers. Upon a seller accepting buyer's offer, the buyer may enter into a real-estate agreement with the seller to buy the property backed by the lender (i.e., by virtue of the guaranteed preapproval). Again, the smart contract record associated with the token will reflect the details of the real-estate agreement between buyer and seller, e.g., the agreed-upon purchase price, the property information, and so on. Additionally, digital wallet identification(s) for lender, borrower (i.e., buyer), and/or seller may be included in the smart agreement. Notably, the execution of the buy-sell agreement may cause a generation of a separate digital representation of the agreement, i.e., an agreement token. This agreement token may be linked to the buyer and buyer's assigned guaranteed preapproval token.

This representative method includes, in any order and in any combination with any of the above or below disclosed features and options: receiving a transaction confirmation indicative of an accepted offer or an agreement to purchase real-estate property by a buyer from a seller based on a guaranteed preapproval from a lender, determining a unique buyer identification code, receiving a validated guaranteed preapproval token associated with the buyer identification code, determining a unique guaranteed preapproval token identification code, generating an agreement token (or a cryptographic digital asset associated with the agreement), the agreement token including a unique agreement identification code (e.g., a key and cryptographic token), linking the cryptographic digital lending asset with the unique buyer identification code and the guaranteed preapproval token identification code, and transmitting to a distributed blockchain ledger (e.g., Bitcoin, Ethereum, Litecoin, etc.), the unique agreement identification code linked with the unique buyer code, and guaranteed preapproval token identification code for recordation on a transaction block.

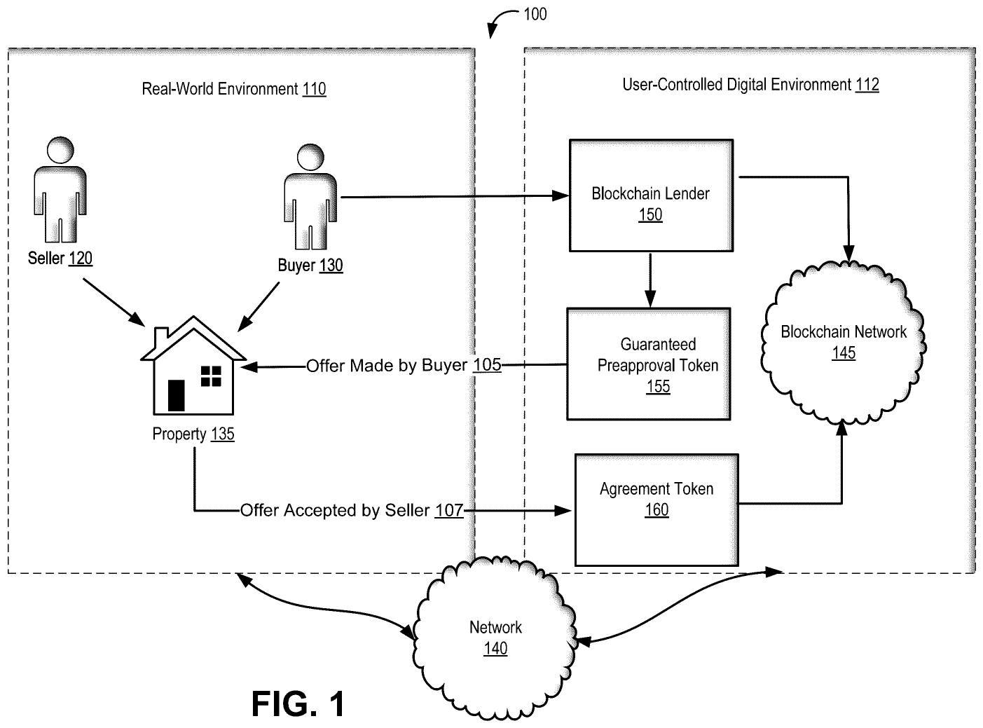

FIG. 1 illustrates exemplary system for generating and swapping cryptographic digital lending assets 100, in accordance with the embodiments disclosed herein. This system 100 includes an example real-world environment 110 and an example user-controlled digital environment 112 (e.g., Metaverse) in communication with a network 140.

In some embodiments, one or more computing systems are connected by one or more communications channels, such as, but not limited to: any general network, communications network, or general network/communications network system; a cellular network; a wireless network; a combination of different network types; a public network; a private network; a satellite network; a plain old telephone service (“POTS”) network, a cable network, or any other network capable of allowing communication between two or more computing systems, as discussed herein, and/or available or known at the time of filing, and/or as developed after the time of filing.

Network 140 includes, but is not limited to, any network or network system such as, but not limited to, a peer-to-peer network, a hybrid peer-to-peer network, a Local Area Network (“LAN”), a Wide Area Network (“WAN”), a public network, such as the Internet, a private network, a cellular network, a POTS network; any general network, communications network, or general network/communications network system; a wireless network; a wired network; a wireless and wired combination network; a satellite network; a cable network; a Virtual Private Network (“VPN”), a Mesh Network (or other many-to-many system); a cryptographic Directed Acyclic Graph (“crypto DAG”); any combination of different network types; or any other system capable of allowing communication between two or more computing systems, whether available or known at the time of filing or as later developed. Some common embodiments may typically comprise an “Internet Protocol” address system and a distributed ledger technology system using cryptographic addresses as end points, but the scope of the present disclosure is not restricted to such. A person of ordinary skill in the art having the benefit of the present disclosure would understand that an address system can be used on multiple network types; for example, Ethereum's DLT technology running Ropstein, Mainnet, Casper, Kovan, Rinkeby, Goerli and Rinkeby networks.

In some embodiments, system 100 may include a real-world environment 110 including a seller 120 offering for sale a real-estate property 135 and a buyer 130 interested in purchasing that property 135. Further, the system 100 may include a user-controlled digital environment 112, including a blockchain lender 150 that issues a guaranteed preapproval to buyer 130 (i.e., a borrower) which is assigned a cryptographic token 155. Buyer 130 enters into an agreement with seller 120 to purchase property 135 on the basis of the assigned token. An agreement token 160 is generated and linked to buyer 130 and the guaranteed preapproval token 155 for the agreement.

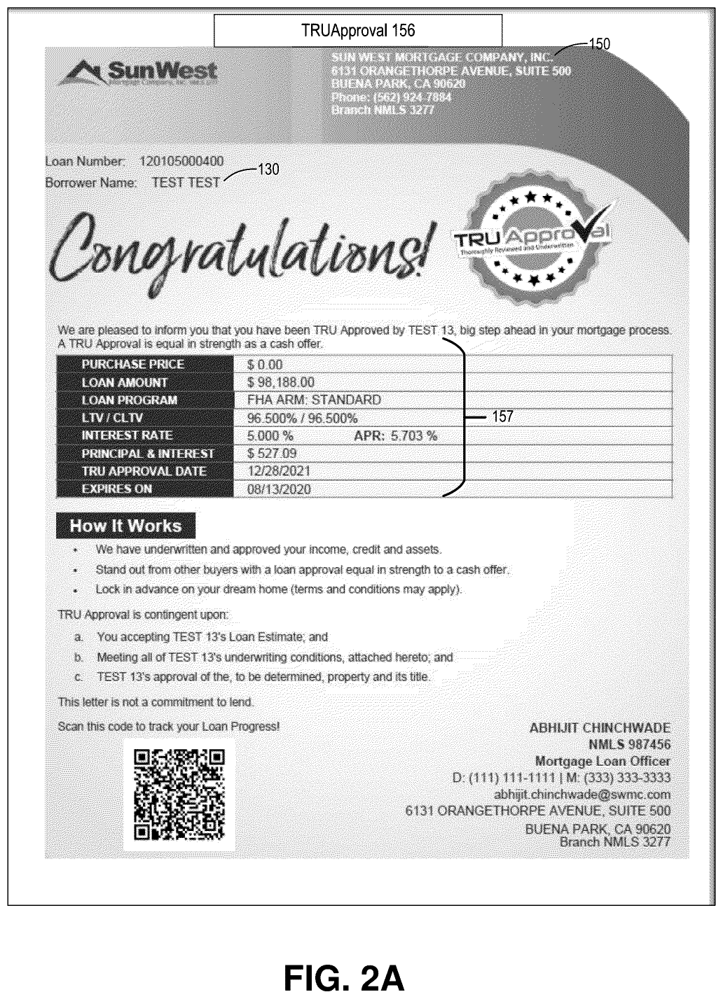

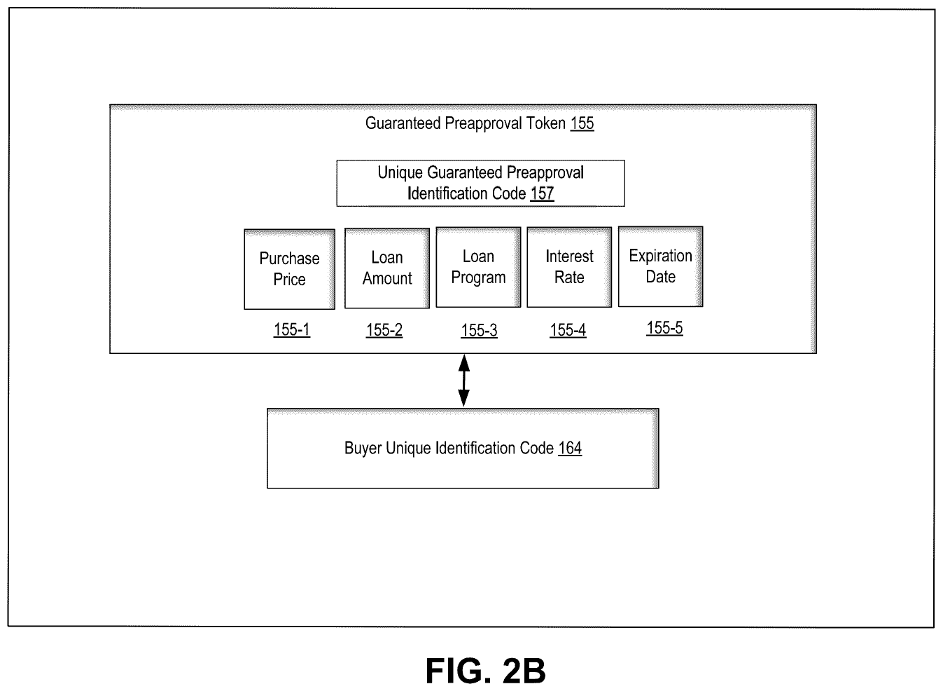

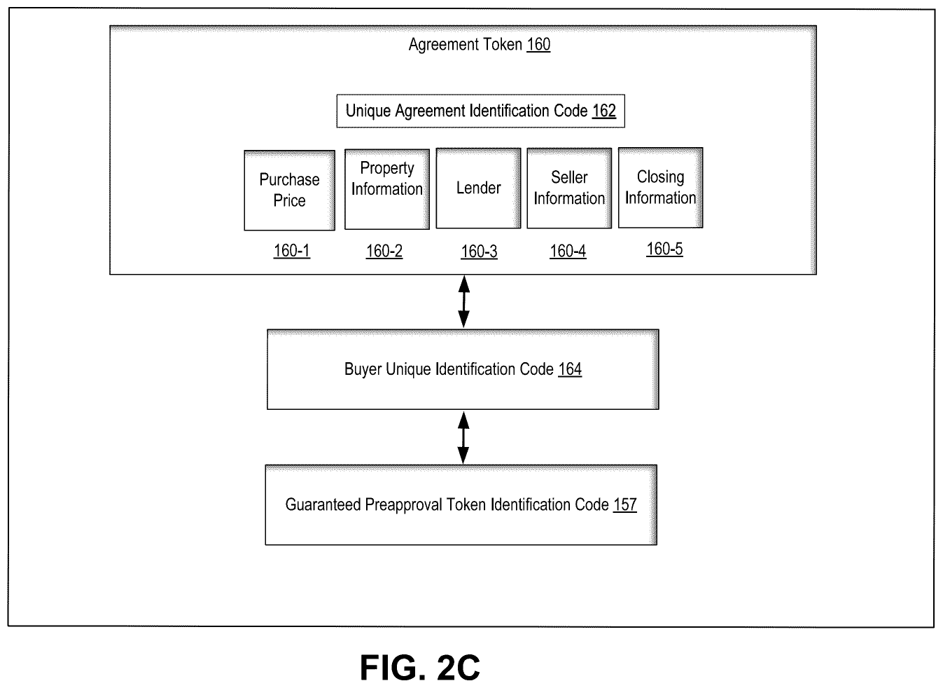

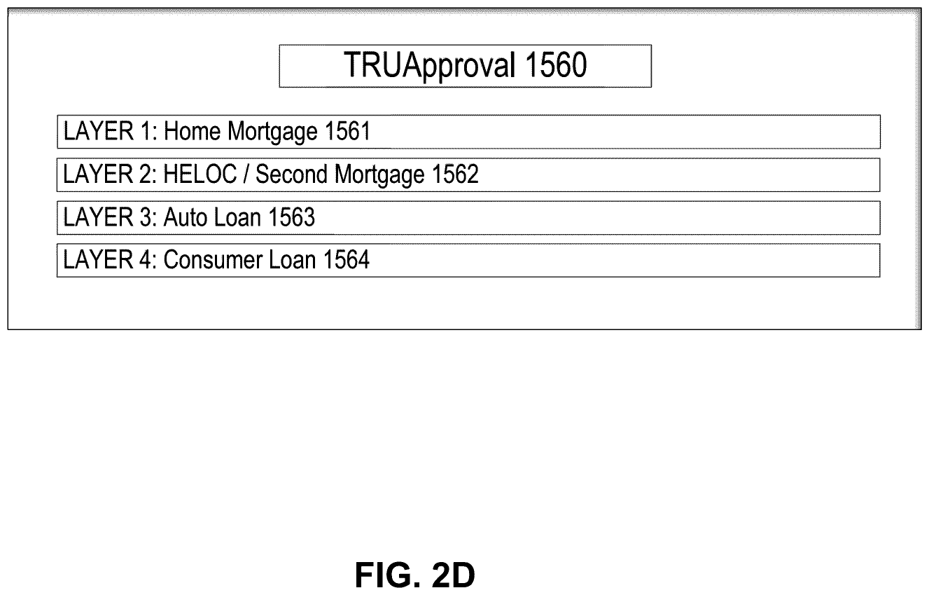

In some embodiments, both the guaranteed preapproval by the blockchain lender and the real-estate agreement between buyer and seller may be signed and prepared in document format. For example, as illustrated in FIG. 2A, a guaranteed preapproval or “TRUApproval” 156 may be issued by lender 150, in this case Sun West, to buyer 130 (the buyer 130 is actually a borrower vis-à-vis the lender). The TRUApproval 156 may include loan information 157 (e.g., purchase price, loan amount, loan program, LTV/CLTV, interest rate, principal and interest, date of issuance, and expiration date, and/or other such similar information). As alluded to above, the TruApproval token 156 issued by lender 150 to buyer 130 and is based on credit and income characteristics of the buyer 130 as determined by lender 150 at the time of issuance.

The issued guaranteed preapproval and the executed real-estate agreement (illustrated in FIG. 1) may be digital scans of paper documents that were hand-signed before scanning and converting to a digital file format such as Portable Document Format (“PDF”), Tagged Image File Format (“TIFF”), and/or other file formats as discussed herein, and/or as known in the art at the time of filing, and/or as developed after the time of filing. In another embodiment, executed guaranteed preapproval and real-estate agreement may exist only as digital files, which are signed digitally before uploading to a third-party database. In various embodiments, the guaranteed preapproval and the real-estate agreement can be any hard copy and/or digital copy of a document or agreement relating to the preapproval issued by the lender.

In some embodiments, the guaranteed preapproval and the real-estate agreement are obtained as electronic data via, as illustrative examples, e-mail or the Internet. In other embodiments, the guaranteed preapproval and the real-estate agreement can be any electronic form of document, including a document generated from a paper document or a document that originated in a digital form. An electronic form of the guaranteed preapproval and the real-estate agreement can include, but is not limited to, PDF file with or without embedded text, an image file depicting the guaranteed preapproval and the real-estate agreement, a word-processing document file, or any other electronic file, as discussed herein, and/or as known in the art at the time of filing, and/or as developed after the time of filing.

The guaranteed preapproval NFT may be a cryptographic digital asset and may refer to any computer-generated virtual object, including digital agreement, that may have a unique, non-fungible tokenized code (“token”) registered on and validated by a blockchain platform or otherwise registered in an immutable database. For example, as illustrated in FIG. 2B, guaranteed preapproval token 155 (illustrated in FIG. 1) may refer to the electronic guaranteed preapproval 156 issued by lender 150 to buyer 130 (illustrated in FIG. 2A). The guaranteed preapproval token 155 may include various attributes such as a purchase price 155-1, a loan amount 155-2, a loan program 155-3, an interest rate 155-4, an expiration date 155-5, and/or other similar attributes. Because the guaranteed preapproval is issued to the buyer based on their financial qualifications and other characteristics of the buyer (FICO score, loan/debt ratio, assets, and/or such similar qualifying criteria) and the terms of the lender's commitment (qualifying amount, max interest rate, etc.), the guaranteed preapproval token 155 is valid as a funding guarantee so long as the buyer abides by the terms and conditions of the smart contract, i.e., the attributes 155-1-155-5. The guaranteed preapproval token 155 may be associated with a unique guaranteed preapproval identification code 157 and may be linked to the unique buyer identification code 164.

### Truapproval Credit Bundle

In some embodiments, a borrower may request, and lender agree, to issue a plurality of guaranteed preapprovals for different lending needs. For example, in addition to a guaranteed preapproval for a mortgage, a lender may issue additional guaranteed preapprovals for other lending instruments, such as a home equity line of credit (“HELOC”), an auto loan, a student loan, a consumer loan, and/or any other loan, or any combination of the above, including bundles of one or more loans.

In some embodiments, the TRUApproval token or NFT, as described with reference to FIG. 2A, may include a bundle of lending products issued by the lender to a consumer. For example, as illustrated in FIG. 2D, TRUApproval NFT 1560 may include a home mortgage guaranteed preapproval 1561, a HELOC guaranteed preapproval 1562, an auto loan guaranteed preapproval 1563, and a consumer loan guaranteed preapproval 1564. The total value of TRUApproval NFT 1560 may be apportioned between the layers of the NFT 1560 such that 60% will be apportioned for 1561, 20% for 1562, 10% for 1563, and remaining 10% for 1564. For example, if the total value of TRUApproval NFT 1560 is $1M, then mortgage 1561 value is $600K, HELOC 1562 value is $200K, auto loan 1563 value is $100K, and consumer loan 1564 value is $100K. Like TruApproval NFT token 156 (illustrated in FIG. 2A), TruApproval NFT 1560 may also be issued by a lender based on credit and income characteristics of a buyer, as determined by the lender at the time of issuance.

The TRUApproval NFT 1560 may be registered on and validated by a blockchain platform and may be managed by a smart contract and an underlying distributed ledger. The smart contract may include a plurality of rules and conditions. For example, a set of rules may be established on the order of the funding of loans bundled within the TRUApproval NFT. For example, home mortgage 1561 may be funded first to ensure that the debt-to-credit ratio is not impacted. In other words, by funding mortgage 1561 before HELOC 1562, auto loan 1563, or consumer loan 1564, allows to maintain optimal debt-to-credit ratio used to issue the guaranteed preapproval for mortgage 1561, which will often be the largest. In some embodiments, the rules may be the rules of the protocol and its transactions are viewable and verifiable by all ensuring complete transparency.

The advantage of bundling multiple guaranteed preapprovals together in this manner allows the consumer to undergo a single underwriting process, thereby lowering consumer costs. Additionally, by recording the bundled guaranteed preapprovals as a single NFT on the blockchain, which is governed by a single set of transparent rules, significantly lowers processing resources, as the need to perform continuous cross-reference of consumer's existing loans, credit score, each time a consumer applies for a loan is removed. It also provides security advantages because the need to store queried data related to credit potential is removed.

### Other Lenders Bidding

Finally, by bundling multiple guaranteed preapprovals together allows a consumer to offer other lenders to bid on the terms of their guaranteed preapprovals. For example, a guaranteed preapproval issued by a qualified lender (e.g., Sun West) informs other lenders that the consumer has been through the rigorous approval process (underwriting) and deserves the guarantee without having to perform their own underwriting. By relying on the underwriting of the original lender, creates lending opportunities for other lender, which may be able to offer more competitive terms or conditions for loans of limited (lower) amounts.

For example, a third-party lender may offer a more competitive interest rate for a $5,000 consumer loan which may be part of the $100K consumer loan bundled in the TRUApproval NFT issued by Sun West. The bidding may be initiated by the consumer. For example, consumer may solicit bids from other lenders on the HELOC loan 1562. The bidding between the lenders may occur through a bidding platform. By contrast, lenders may be able to ender bid automatically during the funding phase of the loan, for example, during a transaction. The transaction may include the consumer using the auto loan 1563 to purchase a car or buying something directly from a merchant before the transaction is completed (i.e., instantaneously, while the consumer is checking out). In some embodiments, a system that allows a merchant to accept TRUApproval NFTs may be provided. For example, to make it merchant friendly, the TRUApproval NFT may be imbedded in a chip similar to a credit card.

Referring back to FIG. 1, once buyer 130 is assigned the guaranteed preapproval token 155 (i.e., by linking the guaranteed preapproval token 155 to the unique buyer identification code 164), buyer 130 can make an offer (indicated in a transaction 105) to buy property 135 from seller 120. In some embodiments the buyer 130 may make the offer in a user-controlled digital environment 112 (e.g., Metaverse) or such similar environments.

Once the seller 120 accepts buyer's offer (indicated in a transaction 107) backed by guaranteed preapproval token 155, a real-estate agreement between the buyer 130 and seller 120 is formed. As alluded, to above, the real-estate agreement can be converted to a non-fungible token (“NFT”) managed a smart contract or smart subcontract and recorded in the blockchain ledger. Additionally, the real-estate agreement can be tracked by wallet, financial locker, and/or similar mechanism.

The closing of the real-estate purchase (i.e., as contemplated in the real-estate agreement) may occur on the closing date provided in the smart contract of associated real-estate agreement token. The closing event may be recorded in the blockchain ledger to, thereby, reflect the consummation of the transaction.

For example, as illustrated in FIG. 2C, real-estate agreement token 160 may include various attributes such as purchase price 160-1, property information 160-2, lender information 160-3, seller information 160-4, closing information 160-5, and/or other similar attributes. The agreement token 160 may be associated with a unique agreement identification code 162 and may be linked to the unique buyer identification code 164 and the guaranteed preapproval NFT 155 (illustrated in FIG. 2A) by referencing its unique identification code 157.

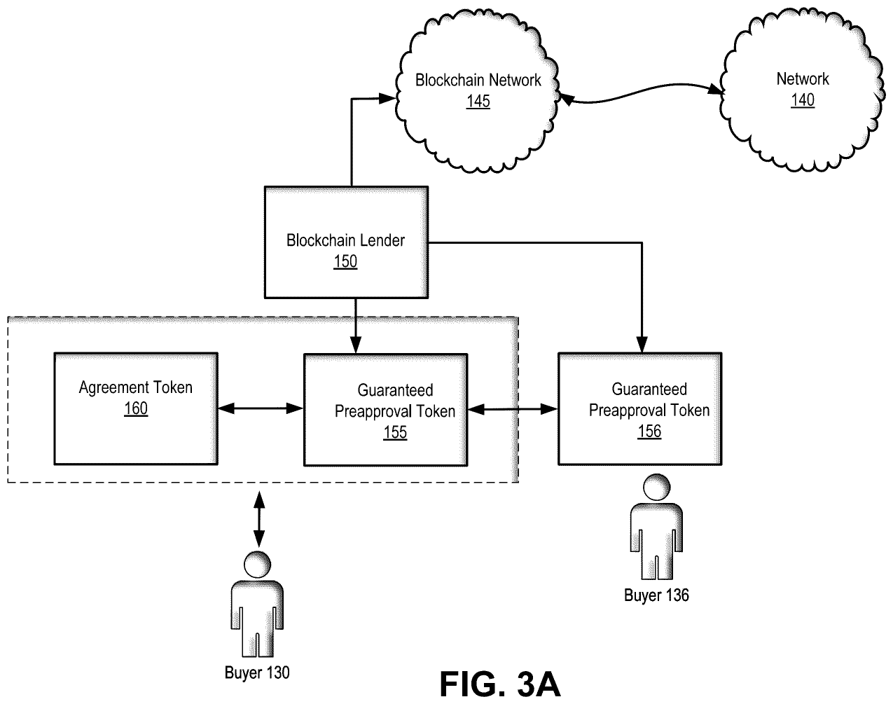

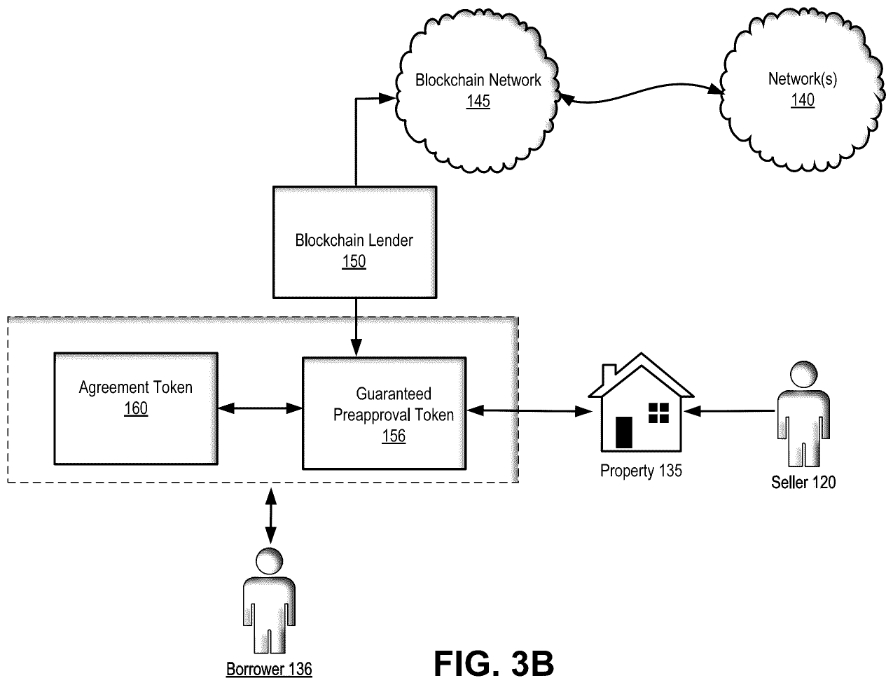

Referring back to FIG. 1, buyer 130, who is effectively the owner of the agreement token 160, may be able to swap the guaranteed preapproval token 155 linked to the agreement token 160 with another comparable preapproval token. For example, as illustrated in FIG. 3A, another buyer, buyer 136, may also obtain a guaranteed preapproval from blockchain lender 150. Upon buyer 136 receiving the guaranteed preapproval from lender 150, the guaranteed preapproval is assigned a cryptographic token 156.

As alluded to above in reference to FIG. 1, buyer 130 may swap the guaranteed preapproval token 155 linked to the real-estate agreement token 160 with guaranteed preapproval token 156 assigned to buyer 136. In essence buyer 130 is transferring his interest in the purchase of property 135 (illustrated in FIG. 1) to buyer 136 by swapping out guaranteed preapproval token 155 with token 156. The “swap” would be another ledger entry on the block chain.

For example, as illustrated in FIG. 3B, upon completing the swap, buyer 136 may act on the agreement to buy property 135 as previously agreed between seller 120 and buyer 130. By virtue of swapping the guaranteed preapproval, as described above, buyer 130 is able to capitalize on the fluctuations of the real-estate market during the pre-closing period. Once the transaction between the buyer 136 and seller 120 closes, that occurrence can be recorded in the blockchain ledger.

Of course, buyer 130 would only be incentivized to make the swap at a financial gain, i.e., if buyer 136 would pay more than what buyer 130 agreed to pay. By virtue of linking the guaranteed preapproval token to the real-estate agreement in a distributed ledger, initial buyer 130 is able to ask a higher preapproval amount and collect the difference during the swap. For example, in conventional real-estate transaction, there is an earnest money deposit requirement that is usually held by the listing realtor. With a blockchain-based transaction, as described above, there are two possibilities of recording that deposit. First, the cash deposit may be kept with the realtor, which is recorded as part of the real-estate agreement smart contract linked to buyer 130 or, alternatively, the cash deposit can be kept with the issuer of guaranteed preapproval (i.e., the lender 150).

When the buyer 130 transfers their interest in the real-estate agreement to buyer 136, buyer 136 is able to see (via the distributed ledger) exactly how much earnest money buyer 130 deposited with the listing agent or relator. Thus, buyer 136 is able to provide that amount to buyer 130 upon receipt of the real-estate agreement NFT from buyer 130.

However, by depositing the earnest money deposit with the realtor creates a timing problem as well as a problem of good funds where one of the buyers is potentially exposed. Rather than making the deposit with the realtor, buyer 136 deposits the money with the issuer of guaranteed preapproval (i.e., the lender 150). That way, the deposit is held by the trusted party and becomes a data point of guaranteed preapproval token 156 linked to buyer 136. Additionally, by using the lender as the party for the earnest deposit, the lender is able to transfer the deposit and the earnings from the transaction to the original buyer. For example, once buyer 130 transfers his interest in the real-estate agreement to buyer 136, the lender can move the money from buyer's 136 account to buyer's 130 account (including the deposit and the earnings). This transfer will be recorded as a transaction in the public ledger as well.

### Multi-Offer

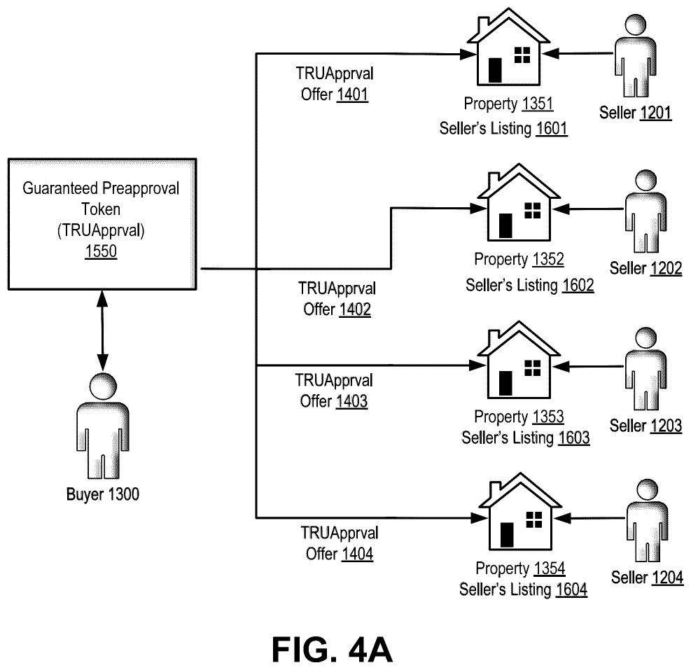

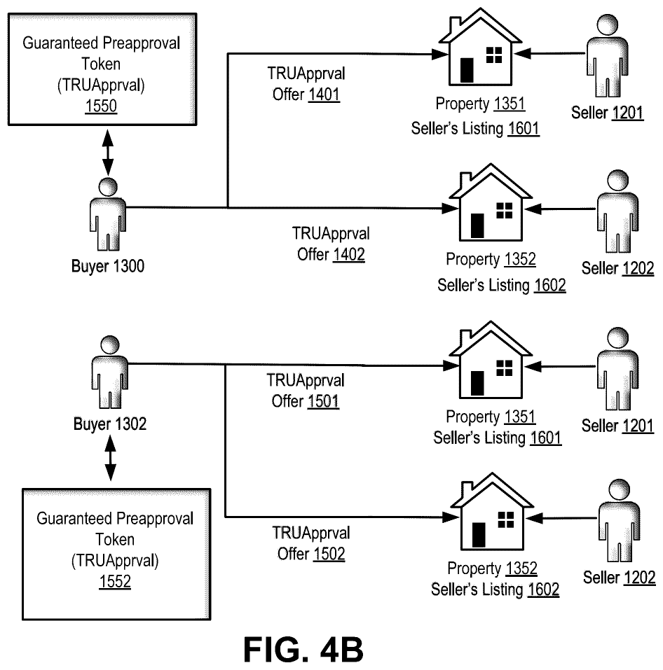

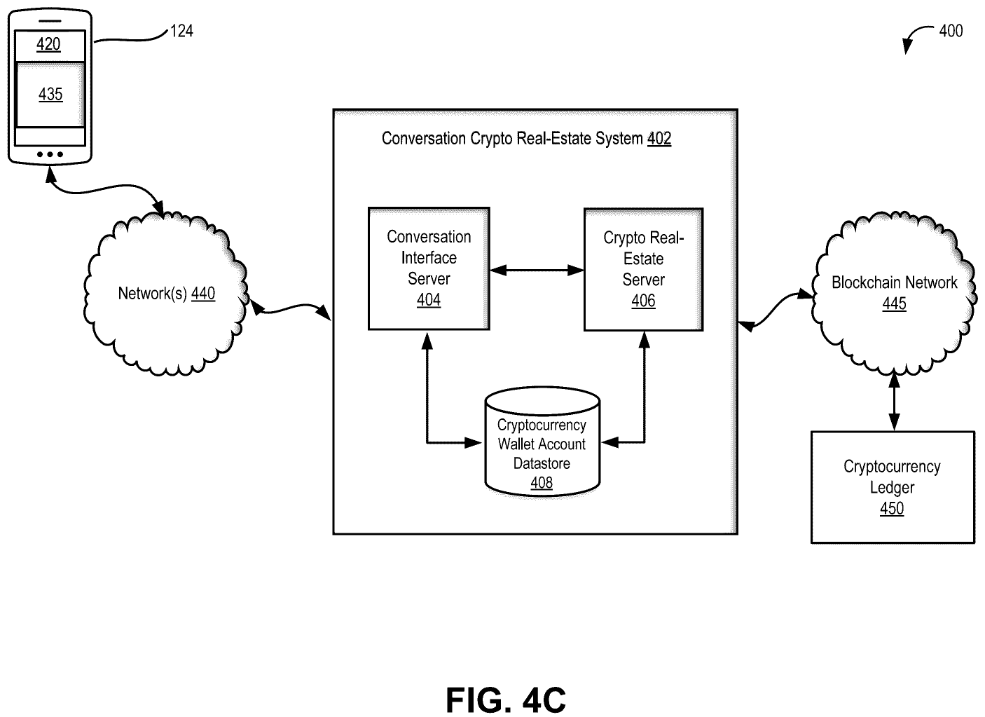

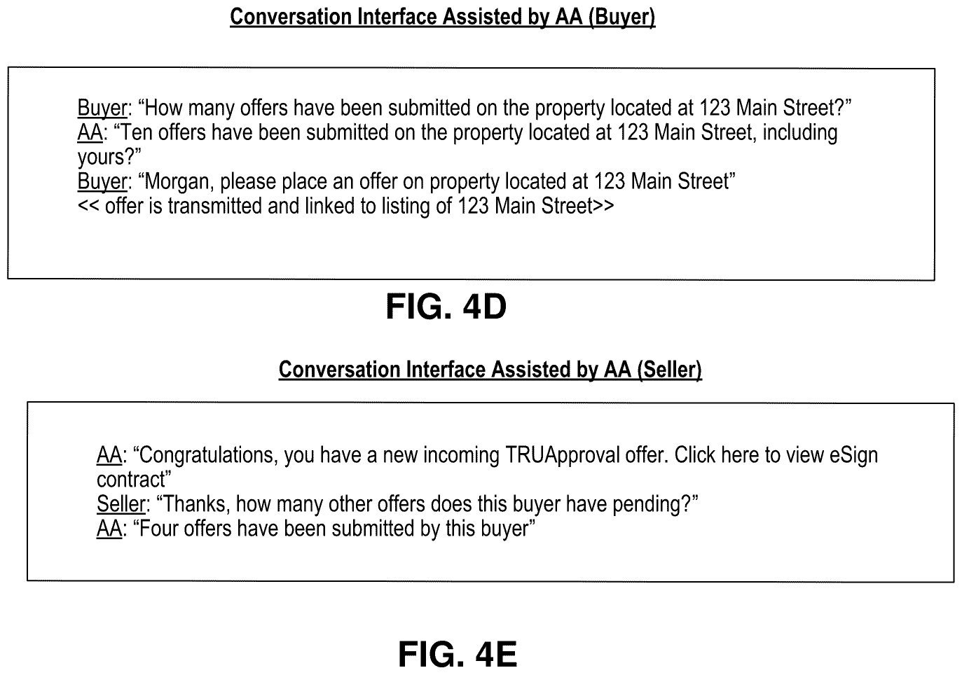

In another embodiment, a buyer having been assigned the guaranteed loan preapproval token, as illustrated in FIG. 1, can make a plurality of offers to buy real-estate from a plurality of sellers. For example, as illustrated in FIG. 4A, buyer 1300 is assigned a guaranteed preapproval token 1550 by a lender. The buyer 1300 uses the token 1550 to make four offers: e.g., a first offer 1401 to buy property 1351 from seller 1201, advertised by seller's listing 1601, a second offer 1402 to buy property 1352 from seller 1202, advertised by seller's listing 1602, a third offer 1403 to buy property 1353 from seller 1203, advertised by seller's listing 1603, and a fourth offer 1404 to buy property 1354 from seller 1204, advertised by sellers listing 1604, respectively. The preapproval token 1550 is thus linked to buyer's offers 1401, 1402, 1403, and 1404 and to seller's listings 1601, 1602, 1603, and 1604.

### Linking and Transparency

That is, each time buyer 1300 makes an offer with the same token, a link is created between the buyer, the property, the listing, and the seller. Each time the preapproval token 1500 is linked to a listing made by the seller, that “link” is an entry on the blockchain. In other words, preapproval token 1550 will show all the offers made by the buyer 1300 linked to it. By virtue of all the offers being linked to the same preapproval token 1550, each seller 1201, 1202, 1203, and 1204 is able to see that buyer 1300 has made three other offers besides theirs.

Because the link between the preapproval token 1500 and seller's listing is recorded on a blockchain ledger, that allows anyone (e.g., seller) to obtain information on any other offers that buyer 1300 has made using the same token 1500. Conversely, blockchain records may be used to determine if other guaranteed preapproval tokens have been linked to that sellers' listing. This information will provide buyers with valuable insight as to what other buyers, if any, are bidding on the same property.

In essence, by using the preapproval token to make offers to buy real-estate provides users with a way to track both all other offers to buy associated with the guaranteed preapproval token and all other offers to buy associated with a listing to which a particular token is linked. Ability to track offers made via the same token and offers on each property listing creates a much-needed transactional transparency that is made possible by virtue of each of these blocs (i.e., token, buyer's offer, seller's listing) being records on the blockchain ledger. For example, knowing that the buyer 1300 has placed three other offers 1402, 1403, and 1404, helps seller 1201 to evaluate buyer's offer 1401. Similarly, as illustrated in FIG. 4B, another buyer 1302 may use their guaranteed preapproval token 1552 to also make offer 1501 to buy property 1351 from seller 1201, advertised by seller's listing 1601, and offer 1502 to buy property 1352 from seller 1202, advertised by seller's listing 1602. Thus, the preapproval token 1552 is linked to buyer 1302 offers 1501 and 1502 to seller's listings and 1601, 1602. By virtue of the links created between buyer 1302 token 1502 and offers 1501, 1502, buyer 1300 may view that another buyer (i.e., buyer 1302) has also made offers (i.e., 1501, 1502) on the same listings 1601, 1602. Without the use of the guaranteed preapproval token, buyers and sellers must rely on their respective realtors, which may not necessarily provide accurate information due to the commission-based nature of real-estate sales. Upon the seller accepting the offer, the acceptance is recorded as yet another block. Any other offers placed using the token associated with the accepted offer may be revoked automatically. Similarly, other pending offers associate with listing whose buyer accepted an offer may be rejected automatically,

### Buyer and Seller Control Access to Content

In some embodiments, the buyer 1300 using token 1550 to make multiple offers can choose whether to make the contents of their entries public. That is, the data such as unique guaranteed preapproval token identification code and unique buyer's offer identification code, may be made public based on buyer's decision to do so. Conversely, if the buyer chooses to keep the contents private, the public will see the block address but not the block's contents. Similarly, when the seller receives an offer to buy seller's property based on the guaranteed loan preapproval token, the seller can choose to make it public. For example, by making it public, everyone will be able to see that the seller's 1201 property located on 123 Main Street has received TRUApprval 1401 offer.

### Using AA

In some embodiments, buyers and sellers may use natural language commands when participating in the real-estate market transactions via a distributed ledger network assisted by an automated software assistant (AA).

FIG. 4C illustrates an example environment 400 for providing a conversation interface assisted by (AA) for enabling real-estate market transactions via a distributed ledger network, in accordance with the embodiments disclosed herein. This diagram illustrates an example environment 400 that may include a conversation crypto real-estate transaction system 402, a client computing device 420, a network 440, a blockchain network 445, and a cryptocurrency ledger 450. The client computing device 420 may be in communication with conversation crypto transfer system 402 via the network 440. The conversation crypto real-estate transaction system 402 may include a conversation interface server 404, a crypto transfer server 406, and a crypto account datastore 408.

In some embodiments, the various below-described components of conversation crypto real-estate transaction system 402 may be used to initiate a client AA-enabled crypto real-estate transaction application 435 (i.e., a distributed application running on client computing device) within client computing device 420. For example, client AA-enabled crypto real-estate transaction application 435 may comprise a chat interface and may be configured to enable sellers and buyers perform real-estate related transactions enabled by crypto real-estate transaction server 406 of system 402. For example, a buyer can place offers via guaranteed preapproval tokens and receive information on the number of pending offers associated with the real-estate property. Similarly, a seller can accept buyer's offer and receive information on the number of any pending offers that buyer may have associated with a preapproval token. A user 124 (e.g., a buyer or a seller) may be associated with a client computing device 420. In some embodiments, the AA-enabled crypto real-estate transaction application 435 may be configured to operate like a crypto wallet application.

The application 435 may be utilized by a buyer Wendy, and a seller Peter, as they interact with AA (e.g., called Morgan) via the application 135 using natural language (“NRL”) commands. For example, as illustrated in FIG. 4D, Wendy could simply ask Morgan “How many offers have been submitted on the property located at 123 Main Street?” In response, system 402 would search the blockchain ledger and provide Wendy with the answer, e.g., “Ten offers have been submitted on the property located at 123 Main Street, including yours.” Buyer Wendy could instruct AA Morgan to place an offer on seller Peter's property located at 123 Main Street using an appropriate NRL, e.g., “Morgan, please place an offer on property located at 123 Main Street.”

Upon a guaranteed preapproval (TRUApproval) offer being submitted, as illustrated in FIG. 4E, seller Peter may receive a message from Morgan, e.g., “Congratulations, you have a new incoming TRUApproval offer. Click here to view eSign contract.” The seller can then ask AA: “Thanks, how many other offers does this buyer have pending?”. In response, system 402 would search the blockchain ledger and provide Wendy with the answer, e.g., “Four offers have been submitted by this buyer.” The AA-enabled interface of the crypto real-estate transaction application 435 allows buyers and sellers to use crypto in real-estate transactions via an open ledger without any prior experience.

By virtue of allowing user to exchange NRL commands, makes the use of the crypto real-estate transactions on the open ledger convenient for both novice and seasoned users alike.

In some embodiments, AA may be configured to use one or more of a deep learning model, a logistic regression model, a Long Short Term Memory (LSTM) network, supervised or unsupervised model, etc. In some embodiments, AA may utilize a trained machine learning classification model. For example, the machine learning may include, decision trees and forests, hidden Markov models, statistical models, cache language model, and/or other models. In some embodiments, the machine learning may be unsupervised, semi-supervised, and/or incorporate deep learning techniques.

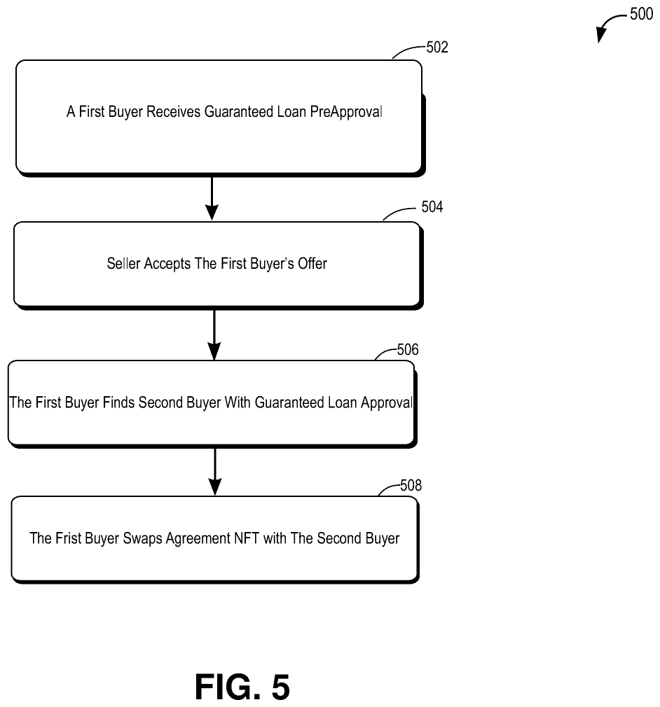

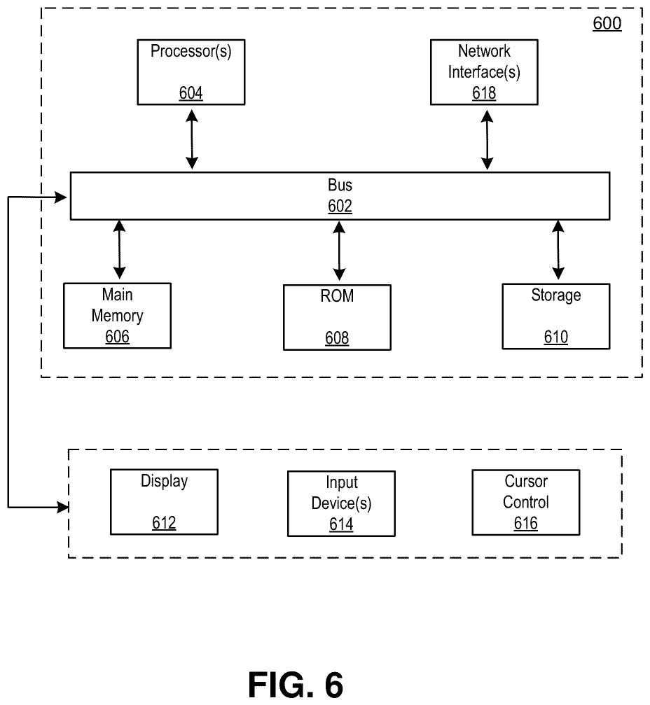

As illustrated in FIG. 5, in step 502, a buyer may receive a guaranteed loan preapproval from a blockchain lender in a user-controlled digital environment in connection with offering to purchase a real-state property from a seller. In step 504, a seller may accept buyer's offer that includes a guaranteed preapproval. In step 506, original buyer may find another buyer that is interested in purchasing the property. This second buyer must have their own guaranteed loan preapproval from a blockchain lender. In some embodiments, this preapproval may be for a higher amount than the asking prices. In step 508, the original buyer may swap the guaranteed preapproval token with that of the second buyer.

Where components or modules of the application are implemented in whole or in part using software, in one embodiment, these software elements can be implemented to operate with a computing or processing module capable of carrying out the functionality described with respect thereto. One such example computing module is shown in FIG. 6. Various embodiments are described in terms of this example-computing module 600. After reading this description, it will become apparent to a person skilled in the relevant art how to implement the application using other computing modules or architectures.

Referring now to FIG. 6, computing module 600 may represent, for example, computing or processing capabilities found within desktop, laptop, notebook, and tablet computers; hand-held computing devices (tablets, PDA's, smart phones, cell phones, palmtops, etc.); mainframes, supercomputers, workstations or servers; or any other type of special-purpose or general-purpose computing devices as may be desirable or appropriate for a given application or environment. Computing module 600 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 600 might include, for example, one or more processors, controllers, control modules, or other processing devices, such as a processor 604. Processor 604 might be implemented using a general-purpose or special-purpose processing engine such as, for example, a microprocessor, controller, or other control logic. In the illustrated example, processor 604 is connected to a bus 602, although any communication medium can be used to facilitate interaction with other components of computing module 600 or to communicate externally. The bus 602 may also be connected to other components such as a display 612, input devices 614, or cursor control 616 to help facilitate interaction and communications between the processor and/or other components of the computing module 600.

Computing module 600 might also include one or more memory modules, simply referred to herein as main memory 606. For example, preferably random-access memory (RAM) or other dynamic memory might be used for storing information and instructions to be executed by processor 604. Main memory 606 might also be used for storing temporary variables or other intermediate information during execution of instructions to be executed by processor 604. Computing module 600 might likewise include a read only memory (“ROM”) 608 or other static storage device 610 coupled to bus 602 for storing static information and instructions for processor 604.

Computing module 600 might also include one or more various forms of information storage devices 610, which might include, for example, a media drive and a storage unit interface. The media drive might include a drive or other mechanism to support fixed or removable storage media. For example, a hard disk drive, a floppy disk drive, a magnetic tape drive, an optical disk drive, a CD or DVD drive (R or RW), or other removable or fixed media drive might be provided. Accordingly, storage media might include, for example, a hard disk, a floppy disk, magnetic tape, cartridge, optical disk, a CD or DVD, or other fixed or removable medium that is read by, written to or accessed by media drive. As these examples illustrate, the storage media can include a computer usable storage medium having stored therein computer software or data.

In alternative embodiments, information storage devices 610 might include other similar instrumentalities for allowing computer programs or other instructions or data to be loaded into computing module 600. Such instrumentalities might include, for example, a fixed or removable storage unit and a storage unit interface. Examples of such storage units and storage unit interfaces can include a program cartridge and cartridge interface, a removable memory (for example, a flash memory or other removable memory module) and memory slot, a PCMCIA slot and card, and other fixed or removable storage units and interfaces that allow software and data to be transferred from the storage unit to computing module 600.

Computing module 600 might also include a communications interface or network interface(s) 618. Communications or network interface(s) interface 618 might be used to allow software and data to be transferred between computing module 600 and external devices. Examples of communications interface or network interface(s) 618 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications or network interface(s) 618 might typically be carried on signals, which can be electronic, electromagnetic (which includes optical) or other signals capable of being exchanged by a given communications interface. These signals might be provided to communications interface 618 via a channel. This channel might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 606, ROM 608, and storage unit interface 610. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 600 to perform features or functions of the present application as discussed herein.

Various embodiments have been described with reference to specific exemplary features thereof. It will, however, be evident that various modifications and changes may be made thereto without departing from the broader spirit and scope of the various embodiments as set forth in the appended claims. The specification and figures are, accordingly, to be regarded in an illustrative rather than a restrictive sense.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the present application, whether or not such embodiments are described and whether or not such features are presented as being a part of a described embodiment. Thus, the breadth and scope of the present application should not be limited by any of the above-described exemplary embodiments.

Terms and phrases used in the present application, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A computer-implemented method, the method comprising:
establishing, by a processor, a first a real-estate transaction application in a data store connected to the processor;
storing, by the processor, login information for the first a real-estate transaction application;
receiving, by the processor, login credentials for the first a real-estate transaction application from a first buyer device;
verifying, by the processor, whether the login credentials match the login information for the first a real-estate transaction application;
upon verifying the login credentials, by the processor, logging the first buyer device into the real-estate transaction application;
obtaining a first input from a first buyer comprising a command to make a first offer to purchase a real estate property sold by a seller using an issued guaranteed mortgage preapproval, the command displayed within a conversation interface of the first real-estate transaction application, the conversation interface configured to receive user input, and display assistant user input comprising one or more responses generated by an assistant user based on the first buyer input;
identifying the issued guaranteed mortgage preapproval obtained by the first buyer from a lender by using the command of the first buyer, the guaranteed mortgage preapproval being represented by a cryptographic digital asset governed by a smart contract on a blockchain, wherein the cryptographic digital asset comprises a non-fungible token (NFT), and wherein the first buyer's guaranteed mortgage preapproval NFT storing first buyer information, property information, and seller information;
preparing a first offer record for storing contract data regarding terms of the first offer in a blockchain or a database; and
linking the guaranteed mortgage preapproval NFT with the first offer record for recordation in a new block in the blockchain distributed ledger.

2. The method of claim 1, wherein the first offer has not been accepted by the seller of the real estate property.

3. The method of claim 2, wherein the first offer is a smart contract that includes computer-readable instructions for verifying, authenticating and approving a property transfer-related event according to the terms and conditions of the first offer.

4. The method of claim 2, further comprising linking the first offer record linked to the guaranteed mortgage preapproval NFT obtained by the first buyer with a record for the real estate property sold by the seller in the blockchain distributed ledger.

5. The method of claim 4, further comprising identifying an issued guaranteed mortgage preapproval obtained by a second buyer in response to obtaining a first input from the second buyer comprising a command to make a second offer to purchase the real estate property sold by the seller using the issued guaranteed mortgage preapproval obtained by the second buyer.

6. The method of claim 5, further comprising:
preparing a second offer record for storing contract data regarding terms of the second offer in the blockchain or the database; and
linking the second buyer's guaranteed mortgage preapproval NFT with the second offer record in the blockchain distributed ledger; and
linking the second offer record linked to the guaranteed mortgage preapproval NFT obtained by the second buyer with the record for the real estate property sold by the seller in the blockchain distributed ledger.

7. The method of claim 6, further comprising:
obtaining a first input from the seller comprising a command to accept the first offer to purchase the real estate property made by the first buyer;
preparing a first acceptance record for storing contract data regarding terms of the acceptance of the first offer in the blockchain or the database; and
linking the first offer record with the first acceptance in the blockchain distributed ledger.

8. The method of claim 7, further comprising:
preparing a first rejection record for storing contract data regarding rejection of the second offer in the blockchain or the database; and
linking the second offer record with the first rejection record in the blockchain distributed ledger.

9. A system comprising:
a processor configured for:
establishing, by a processor, a first a real-estate transaction application in a data store connected to the processor;
storing, by the processor, login information for the first a real-estate transaction application;
receiving, by the processor, login credentials for the first a real-estate transaction application from a first buyer device;
verifying, by the processor, whether the login credentials match the login information for the first a real-estate transaction application;
upon verifying the login credentials, by the processor, logging the first buyer device into the real-estate transaction application;
obtaining a first input from a first buyer comprising a command to make a first offer to purchase a real estate property sold by a seller using an issued guaranteed mortgage preapproval, the command displayed within a conversation interface of the first real-estate transaction application, the conversation interface configured to receive user input, and display assistant user input comprising one or more responses generated by an assistant user based on the first buyer input;
identifying the issued guaranteed mortgage preapproval obtained by the first buyer from a lender by using the command of the first buyer, the guaranteed mortgage preapproval being represented by a cryptographic digital asset governed by a smart contract on a blockchain, wherein the cryptographic digital asset comprises a non-fungible token (NFT), and wherein the first buyer's guaranteed mortgage preapproval NFT storing first buyer information, property information, and seller information;
preparing a first offer record for storing contract data regarding terms of the first offer in a blockchain or a database; and
linking the guaranteed mortgage preapproval NFT with the first offer record for recordation in a new block in the blockchain distributed ledger.

10. The system of claim 9, wherein the first offer has not been accepted by the seller of the real estate property.

11. The system of claim 10, wherein the first offer is a smart contract that includes computer-readable instructions for verifying, authenticating and approving a property transfer-related event according to the terms and conditions of the first offer.

12. The system of claim 10, further comprising linking the first offer record linked to the guaranteed mortgage preapproval NFT obtained by the first buyer with a record for the real estate property sold by the seller in the blockchain distributed ledger.

13. The system of claim 12, further comprising identifying an issued guaranteed mortgage preapproval obtained by a second buyer in response to obtaining a first input from the second buyer comprising a command to make a second offer to purchase the real estate property sold by the seller using the issued guaranteed mortgage preapproval obtained by the second buyer.

14. The system of claim 13, further comprising:
preparing a second offer record for storing contract data regarding terms of the second offer in the blockchain or the database; and
linking the second buyer's guaranteed mortgage preapproval NFT with the second offer record in the blockchain distributed ledger; and
linking the second offer record linked to the guaranteed mortgage preapproval NFT obtained by the second buyer with the record for the real estate property sold by the seller in the blockchain distributed ledger.

15. The system of claim 14, further comprising:
obtaining a first input from the seller comprising a command to accept the first offer to purchase the real estate property made by the first buyer;
preparing a first acceptance record for storing contract data regarding terms of the acceptance of the first offer in the blockchain or the database; and
linking the first offer record with the first acceptance in the blockchain distributed ledger.

16. The system of claim 15, further comprising:
preparing a first rejection record for storing contract data regarding rejection of the second offer in the blockchain or the database; and
linking the second offer record with the first rejection record in the blockchain distributed ledger.
